(19) United States
(12) Patent Application Publication
(10) Pub. No.: US 2005/0193043 A1
(43) Pub. Date: Sep. 1, 2005

(54) System and method for processing audit records

(76) Inventor: Dennis Hoover, Downingtown, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/068,015

(22) Filed: Feb. 28, 2005

Related U.S. Application Data
(60) Provisional application No. 60/547,894, filed on Feb. 26, 2004.

(51) Int. Cl. G06F 17/30

(52) U.S. Cl. 707/204

(57) ABSTRACT

A system and method is provided for processing audit records indicating events associated with particular users initiating actions performed on particular objects. The system of the invention comprises an acquisition processor for acquiring message data including data representing an audit record of a particular type, an audit data processor for, creating a copy of the received audit record, communicating data representing the received audit record to a destination in response to predetermined configuration information that determines audit record processing requirements, receiving message data indicating confirmation that the destination has successfully received the communicated audit record, and re-communicating a copy of the received audit record to the indicated destination, in response to failure to receive a confirmation.

### CROSS REFERENCE TO RELATED APPLICATIONS

This is a non-provisional application of provisional application Ser. No. 60/547,894 by Dennis Hoover filed Feb. 26, 2004

### FIELD OF THE INVENTION

The present invention relates to a system and method for processing records and more specifically for processing audit records.

### BACKGROUND OF THE INVENTION

A healthcare institution typically supports multiple applications that generate security and/or health care related audits. To monitor appropriate use of the applications, an administrator or auditor is tasked with gathering together the audit records generated by the multiple applications in a single repository to view or report on them. One of the difficulties in collecting the audit records and making a proper analysis of the aggregate data is that, in some non-centralized systems, audit records are collected on the machine on which they were generated with no mechanism in place for transferring the locally collected records to a single repository. Another difficulty encountered in collecting the audit records and making a proper analysis of the aggregate data is that different applications write to different repositories, even on the same machine. Accordingly, any aggregation of audit records from the different repositories to one central repository is done by a batch mechanism that is distinct from the system that collected the records. In this case, the auditor is not sure that a significant audited event is going to be delivered to the central repository.

For those systems that do not write to a central repository (i.e., non-centralized systems), an auditor needs to examine multiple local repositories manually making proper analysis of the aggregate data difficult or impossible. For those systems that do write to a central repository (i.e., centralized systems), audit records cannot be collected if the network becomes unavailable. Existing healthcare systems of either type (centralized or non-centralized) do not guarantee delivery of records to a central repository. Another drawback of present day systems of either type (i.e., centralized or non-centralized) is the co-mingling of security and health care auditing data with non-auditing information such as diagnostic and logging information.

### SUMMARY OF THE INVENTION

Accordingly, it is desirable to provide a system and method that collects health-care and security related audit records from multiple sources and routes them to a central audit record repository to view and report on them. Further, to ensure that no significant audited events are missed, the system and method needs to utilize policy definitions to guarantee that audit records that are deemed significant are delivered to the central audit record repository.

The present invention overcomes the above-noted and other deficiencies of the prior art by providing an audit trail system and method for aggregating health care and security related audit records in different formats sourced from different applications on different systems and routing the audit records to a central audit record repository to allow an auditor to effectively monitor the applications being audited. Delivery of the audit records is guaranteed by a store and forward mechanism at each “hop” in a route from record creation to eventual storage in the central audit record repository. Appropriate use of policy definitions allows the audit trail system to selectively collect those audit records that are relevant to auditors at a particular site thereby making analysis of the data easier and lowering the cost of storing and analyzing the data.

Certain exemplary embodiments of the invention provide a system for processing an audit record comprising: an acquisition processor for acquiring message data including data representing an audit record of a particular type. An audit data processor for: creating a copy of the received audit record, communicating data representing the received audit record to a destination in response to predetermined configuration information determining audit record processing requirements, receiving message data indicating confirmation that the destination has successfully received the communicated audit record, and re-communicating a copy of the received audit record to the indicated destination in response to a failure to receive the confirmation.

### BRIEF DESCRIPTION OF THE DRAWINGS

A wide array of potential embodiments can be better understood through the following detailed description and the accompanying drawings in which:

FIG. 1 is a block diagram of an exemplary embodiment of a system 1000 in which the invention may be implemented;

FIG. 2 is a flow diagram of an exemplary embodiment of a method 2000 of processing an audit record, according to one embodiment;

FIG. 3 is an illustration of an exemplary audit record message 3000; and

FIG. 4 is an illustration of a policy management screen 4000 to allow an administrator to add, delete or modify existing audit policies, according to one embodiment.

### DEFINITIONS

When the following terms are used herein, the accompanying definitions apply:
client—an information device and/or process running thereon that requests a service of another information device or process running thereon (a “server”) using some kind of protocol and accepts the server's responses. A client is part of a client-server software architecture. For example, a computer requesting the contents of a file from a file server is a client of the file server.
database—one or more structured sets of persistent data, usually associated with software to update and query the data. A simple database might be a single file containing many records, where the individual records use the same set of fields. A database can comprise a map wherein various identifiers are organized according to various factors, such as identity, physical location, location on a network, function, etc.
executable application—code or machine readable instructions for implementing predetermined functions including those of an operating system, healthcare information system, or other information processing system, for example, in response to a user command or input.
executable procedure—a segment of code (machine readable instruction), sub-routine, or other distinct section of code or portion of an executable application for performing one or more particular processes and may include performing operations on received input parameters (or in response to received input parameters) and provide resulting output parameters.
HIPAA—Health Insurance Portability and Accountability Act of 1996, including any amendments or successors thereto.
information—data
network—a coupling of two or more information devices for sharing resources (such as printers or CD-ROMs), exchanging files, or allowing electronic communications there-between. Information devices on a network can be physically and/or communicatively coupled via various wire-line or wireless media, such as cables, telephone lines, power lines, optical fibers, radio waves, microwaves, ultra-wideband waves, light beams, etc.
processor—a processor as used herein is a device and/or set of machine-readable instructions for performing tasks. As used herein, a processor comprises any one or combination of, hardware, firmware, and/or software. A processor acts upon information by manipulating, analyzing, modifying, converting or transmitting information for use by an executable procedure or an information device, and/or by routing the information to an output device. A processor may use or comprise the capabilities of a controller or microprocessor.
repository—a memory and/or a database.
object—as used herein comprises a grouping of data, executable instructions or a combination of both or an executable procedure.
patient—one who is scheduled to, has been admitted to, or has received, health care.
server—an information device and/or software that provides some service for other connected information devices via a network.
user interface—a tool and/or device for rendering information to a user and/or requesting information from the user. A user interface includes at least one of textual, graphical, audio, video, animation, and/or haptic elements.

### DETAILED DESCRIPTION

In a preferred embodiment, a system is described herein for aggregating health care and security related audit records in different formats sourced from different applications on different systems in a central audit record repository for unified reporting on auditable events across health care applications and systems, analysis by an auditor to effectively monitor the applications being audited or as an historical record.

While the system is described herein in the context of a health care enterprise site in which multiple auditing health care applications create audit records, such is discussed by way of example. Those skilled in the art will appreciate that the system provides a solution to any application that desires to audit data and have the audited records collected in a central repository. That is, the system is applicable to processing and storing audit records that indicate events associated with a particular user initiating an action performed on an object such as a data item or multiple data items, an action or an executable procedure.

The system, in the context of a health care enterprise site, provides traceability of sensitive actions back to the individuals making them. These sensitive actions may be security related, as in signing on to the system, or they may be healthcare related, as in a doctor modifying a patient record. In either case, HIPAA regulations mandate that a persistent record of the activity is generated, stored and made confidential throughout its lifetime. In addition to providing a solution to the afore-mentioned requirements, it is recognized that most, if not all, applications have sensitive actions that require auditing. If the audit records generated from these applications were written to separate, diverse data stores, the system becomes difficult to administer and difficult to audit. Accordingly, the system writes audit records from applications, irrespective of their sensitivity, to a central repository where they can be easily viewed and administered.

The system described herein is preferably implemented as a platform independent Java implementation. However, the system may be implemented in various embodiments using other well known implementations, such as, for example, C++. The executable applications, as described herein, are computer programs (also referred to as computer control logic) stored within the main memory or a secondary memory on any suitable computer running Windows 2000, Linux on S390 and Solaris. Such computer programs, when executed, enable a processor to perform the features of the present invention. The system as disclosed herein can be implemented by a programmer, using commercially available development tools. Obviously, as technology changes, other computers and/or operating systems may be preferable in the future.

In addition to the features described above, the system provides a number of specific features and advantages over prior art systems including, without limitation: the collection of audit data in a central audit record repository; the guarantee of the delivery of an audit trail record to the central audit record repository; the assurance that an audit record is delivered to the central audit record repository once; persistence of the audit records in the central audit record repository until they are no longer needed as specified by relevant regulatory requirements and/or customer administrators; the assurance that no audit records are lost; ensuring the integrity and confidentiality of the audit record throughout its lifetime; the use of policy-based audit record filtering to eliminate the collection of unwanted and irrelevant data in the central repository which serves to both reduce the storage and transmission costs and makes the collected data easier to analyze; unified reporting on auditable events across applications and systems; relevant audit data made available for analysis; the encryption of the audit data during transmission to prevent the unauthorized viewing of sensitive audit data; digitally signed data to ensure that sensitive audit data is not tampered with during transmission; data translation from an original audit data record format, provided by a source application, to a format required by the central audit record repository thereby ensuring that new record formats are supported by the system without changing the system configuration to accommodate the new record formats; custom configuration of the system to selectively record or not record, certain types of audit records through a policy catalog included as part of the system; Enterprise to single workstation and; and cost effectiveness over the entire scale.

The system is capable of accepting standard compliant audit records generated by third party components via standard protocols. More particularly, the system is capable of accepting audit records that conform to published standards by various standards organizations such as the IHE (Integrated Healthcare Environment consortium). The IHE publishes multiple versions of its standard, i.e., a “year 4” audit record standard and a “year 6” audit record standard. The system is capable of accepting audit records in accordance with both the IHE year 4 and year 6 standards. The system also supports mechanisms for network transport between auditing systems as defined by standards organizations such as the “secure syslog” standard that is used for communicating audit records between systems. The system supports present and future versions of “secure syslog” as its transport protocol.

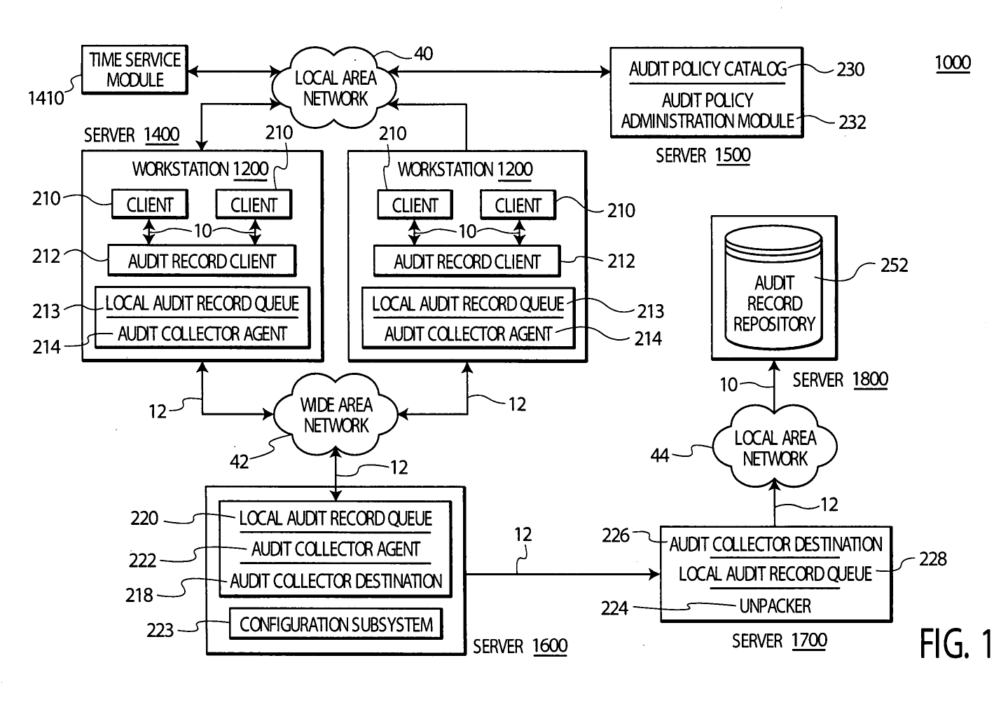

FIG. 1 is a block diagram of a system 1000 in which the invention may be implemented. System 1000 comprises one or more workstations 1200 (two are shown for simplicity). The workstations 1200 may include one or more applications 210 (two are shown associated with workstations 1200 for simplicity) that generate audit records 10 comprised of event information. Examples of some typical applications 210 that generate audit records include, without limitation, an application that validates that a user has entered the correct password. Such an application might audit invalid password attempts. Another example is an application that allows a doctor to prescribe drugs to be administered to a patient. Such an application might audit prescriptions for controlled substances. Yet another example is an application that allows users to order equipment and supplies. Such an application might audit orders placed over a certain dollar amount.

In use, the applications 210 generate audit records 10 which contain event information. The event information is associated with a particular user initiating an action performed on an object such as a data item or multiple data items, an action or an executable procedure. The audit records 10, generated by the applications 210, are received by the audit record client 212 as the principle interface to the system of the invention through a set of public application programming interfaces (APIs) callable by the applications 210. The audit record client 212 adds information to the audit records 10. The added information referred to herein as an “audit record envelope”. The information added to the audit records 10 includes at least two of the following: a record type identifier identifying a type of said audit record, a record data format identifier, a time and date identifier identifying a time and date associated with said audit record and information for use in identifying a destination to which said received audit record is to be communicated. The data format identifier is used to either select a procedure to use in processing data representing said audit record to be suitable for communication to the central data repository 252, or process data representing the audit record 10 to be suitable for communication to the central data repository 252.

An audit record 10 combined with and audit record envelope comprises, what is referred to herein as an “audit record message” 12. The audit record messages 12 are stored in the local audit record queue 213 of workstation 1200 until they can be forwarded by the audit collector agent 214 to the audit collector destination 218 of the next ‘hop’ in the route, namely, server 1600. A copy of the audit record message 12 is maintained in the local audit record queue 213, while another copy is transmitted to the audit collector destination 218 of the next ‘hop’ in the route. After the audit collector destination 218 of the next ‘hop’ in the route provides positive confirmation that it has received the audit record message 12 in its entirety and has made a copy of the audit record message 12 in the local audit record queue 220 of the destination, can the sending ‘hop’ safely delete its stored copy of the audit record message 12. If the audit record message 12 is transmitted to a destination on another machine, and no confirmation is received, the audit collector agent 214, 222 on the sending system will start the process over again. Specifically, it establishes communication with the destination, transfer the record, and wait for confirmation. In practice, the audit collector agent has a limit on how many times it tries this before giving up and writing/sending an error message indicating that the destination appears to be permanently unavailable or non-functional.

Such agent-destination interactions continue in accordance with a “store and forward” protocol until the audit record messages 12 reach the centralized audit record repository 252 of server 1800. Prior to storing audit records 10 in the central audit record repository 252, at the final ‘hop’ in the route, e.g., server 1700, a reverse process occurs whereby the audit record message 12 is deconstructed (i.e., the envelope is removed) to extract the audit record 10 for storage in the centralized audit record repository.

In the system 1000 of FIG. 1, the workstation 1200 and servers 1600 and 1700 represent ‘hops’ in the route from audit record creation to eventual storage in the audit record repository 252 in accordance with the “store and forward” protocol. The ‘hops’ in the route comprise an audit collector agent, a local audit record queue and an audit collector destination. It is noted that minor variations occur at the first and last ‘hops; to be described below with reference to Table I.

At each ‘hop’ in the route, a store and forward protocol is implemented. Specifically, the audit record messages 12, received from the audit collector agent of the previous ‘hop’ in the route are written to the local audit record collector queue (of the current ‘hop’) by the local audit collector destination (of the current ‘hop’). The audit record messages written to the local audit record collector queue (of the current ‘hop’) are thereafter asynchronously read from the local audit record collector queue by the audit collector agent (of the current ‘hop’) to be sent to the audit collector destination of the next hop in the route.

Table I is provided to illustrate distinctions between the intermediate ‘hops’ in the route (e.g., server 1600) and the first and last ‘hops’ (workstation 1200 and server 1700). It should be appreciated that while system 1000 illustrates a single intermediate node, many intermediate nodes may be employed, as needed.

TABLE I

| “Hop” | | Forwarding | |
|---|---|---|---|
| (i.e. Device) | Hop Order | component | Storing component |
| Workstation 1200 | First | Applications 210¹ | Audit record client² |
| Server 1600 | Intermediate | Audit | Audit collector |
| | | collector agent | destination (subtype: |
| | | | transfer destination) |
| Server 1700 | Last | Audit | Audit collector |
| | | collector agent | destination (subtype: |
| | | | unpacker |
| | | | destination) |
| Note 1: | | | |
| For the first ‘hop’ of the route, i.e., the applications 210 act like audit collector agents, in that they send or “forward” audit records into the system 1000. It is not, however, an “audit collector agent” (e.g., audit collector agent 214) as defined herein. | | | |
| Note 2: | | | |
| For the first ‘hop’ in the route, i.e., workstation 1200, the audit record client 212 acts like a conventional “audit collector destination” in that it writes the audit records 10 to the ocal audit record queue 213. However, the audit record client 212 is | | | |
| # distinguishable from a conventional “audit collector destination” in that a conventional audit collector destination is implemented as a centralized service that is coupled to server 1600 via a network connection. The audit record client 212 does not require a network | | | |
| # connection and instead writes audit records 10 locally for increased reliability. Writing records locally is achieved by direct coupling of the audit record client 212 to the local audit record queue. Direct coupling circumvents any potential problems arising from network failures. | | | |

It is further noted that while the ‘hops’ in the route include a local audit record queue (e.g., queues 213, 220, 228), the first and last ‘hops’ in the route (i.e., workstation 1200 and server 1700) have special considerations, in that they interface with components outside the system. Specifically, the workstation 1200 interfaces with the various applications 210, and server 1700 interfaces with the audit record repository 252.

It is further noted that the audit record repository 252, not an element of the system of the invention, is preferably implemented as any well known database management system, but may be otherwise implemented as any well known storage device.

As briefly discussed above, the audit collector destination (e.g., destination 218) is a centralized service that receives audit records 10 from the collector agents of various applications 210 associated with the one or more workstations 1200 and ensures that the audit records 10 are written to the audit record repository 252 based on configuration information from the configuration subsystem 223. The audit collector destination is configured to write the audit records 10 to a local audit record queue (e.g., queue 220) for storage until delivery to the next audit collector agent or the audit record repository 252 has been confirmed in accordance with the “store and forward” protocol.

The audit collector destination is an abstract interface that supports two different destination types, depending on the configuration information contained in the configuration subsystem 223. The two different destination types include a transfer destination type and an unpacker destination type. For the transfer destination type, an audit record 10 is received by the transfer destination agent type. The transfer destination agent type, for example, transfers the audit record 10 untouched to an audit collector queue. For the unpacker destination type, the audit record 10 first extracts and decrypts the audit record if necessary, then dynamically instantiates an audit repository unpacker and passes the audit record 10 to the unpacker 224. The unpacker 224 is responsible for the final disposition of the audit record 10 in the audit record repository 252. FIG. 1 illustrates an transfer destination agent type 218, shown as a component of server 1600 and an unpacker destination type 226, shown as a component of server 1700. In certain embodiments, the unpacker destination type 226 can be implemented as a part of the audit record repository 252.

It is instructive at this point to describe the different types of unpackers that may be employed. One characteristic of the system is that it is extensible, meaning that more than one format of audit record is supported. For example, there is an interim audit record schema specified by the IHE (a standards body), referred to as the “IHE Year 4 schema” and a final one, referred to as the “IHE Year 6 schema”. Since the record formats are different, different unpacking logic is employed to extract the audit record information and write it to the audit record repository 252. The unpacker queries the record message envelope to determine the format and invoke the “appropriate” unpacker (the unpacker that understands the information). So, there are separate unpackers for the IHE Year 4 and year 6 schemas. The unpacker queries the configuration system 223 to determine the “appropriate” unpacker, given the determined format, and invoke that unpacker. If a new format were introduced (a hypothetical IHE year 8, for example), then a new unpacker is written and added to the system along with a new entry in the configuration system 223 to allow it to be invoked.

With continued reference to FIG. 1, the workstations 1200 are coupled via a communication network (LAN) 40 to a “time service” server 1400 which includes a time service component 1410 and a “policy catalog” server 1500 which includes an audit policy catalog 230 and an audit policy administration module 232. The “time service” server 1400 and “policy catalog” server 1500 act as servers in a client-server relationship with the workstations 1200, as shown in FIG. 1. However, in certain embodiments, the “time service” server 1400 and “policy catalog” server 1500 may also constitute different components included in the workstation 1200.

The “time service” server 1400 supports the system by providing a trusted time source for time stamping audit records 10. The “time service” server 1400 includes a time service component 1410 to reliably provide a current time in UTC format. The multiple applications 210 and the audit record client 212 use the time service component 1410 as an authoritative source for timestamps or as a periodic check to ensure that the difference between the local time and the authoritative time is within limits as specified within a configuration component 223. It is noted that the time service provision is optional and not required in those cases where the local server time is reliable.

The “policy catalog” server 1500 includes the audit policy catalog component 230 and the audit policy administration module 232 which are called by the audit record client 212 of the workstations 1200 to determine which audit records 10 are created and stored by the system. The audit policy catalog 230 is configured to perform policy checks prior to audit record creation and coordinate policy administration. Different policies are implemented which depend upon legal regulations and enterprise or departmental strategies. The policies describe the circumstances under which audit generation occurs. Policy checks are performed by mapping generated audit records 10 to specific audit policies. The policies contained within the audit policy catalog 230 exist in one of two states, enabled or disabled. In the case where a policy is enabled, the audit record types contained in the policy are collected. Conversely, in the case where a policy is disabled, the record types contained in the policy are not collected and discarded.

The policies stored in the audit policy catalog component 230 can include, in certain exemplary embodiments, a data retention time, which is the minimum amount of time audit records of the types contained in the policy catalog are to be retained in the central audit record repository 252, whether an audit record 10 of a particular type is to be communicated to a destination and whether an audit record 10 of a particular type is to be acquired.

It should be appreciated that there is no limit to the number of audit record types that can be contained within an audit record policy. Further, an audit record type may be included more than one audit record policy. If an audit record type appears in multiple audit record policies, that audit record type is collected if at least one of the audit record policies it appears in is enabled. If an audit record type does not appear in any of the audit record policies, that record type is never collected.

With continued reference to FIG. 1, system 100 further comprises remote servers 1600, 1700 and 1800. In certain embodiments, the remote servers 1600, 1700, 1800 may be configured as local or remote, dependent upon a number of factors related primarily to network bandwidth requirements and cost.

Remote server 1600 comprises a local audit collector destination 218, a local audit record queue 220, a local audit collector agent 222 and a configuration subsystem 223. The configuration subsystem 223 supports the system by providing information regarding the location of necessary sub-components of the system. Static files with name value pairs, such as Windows INI files, are acceptable as the configuration subsystem 223. The audit collector agent 222 is responsible for sending audit record messages 12 to a next ‘hop’ in a route (e.g., server 1700). The audit collector destination 218 is responsible for receiving audit record messages 12 from the audit collector agent 214 of the previous ‘hop’ in the route (e.g., workstation 1200). The local audit record queue 220 stores audit record messages 12 until they can be forwarded to the next “hop” in the route (i.e., server 1700).

Remote server 1700 comprises a local audit collector destination 226, a local audit record collector queue 228 and an unpacker 224. It is noted that because remote server 1700 exists on the boundary of the system (i.e., the last forwarder prior to storage of the audit records 10) it does not require an audit collector agent as required by the other ‘hops’. Similarly, because workstation 1200 exists on a boundary of the system (i.e., the first forwarder of audit records 10), it does not require an audit collector destination as is true of the other ‘hops’. The unpacker 224 of server 1700 reads from the local audit record collector queue 228 in the same manner as an audit collector agent. In addition, it also writes audit records 10 to the audit record repository 252 of server 1800. Before the unpacker 224 writes audit records 10 to the audit record repository 252, it calls a routine specific to the format of the event information to ‘unpack’ the event information from the audit record message 12, as discussed above. It is noted that the unpacking operation is the reverse operation performed by the applications 210 which ‘pack’ event information into the audit records 10.

Remote server 1800 includes the centralized audit record repository (database) 252 in which the audit records 10 are eventually permanently stored. The repository 252 prevents unauthorized access to the stored audit records 10 and ensures that the audit records 10 are not modified after they are stored. The repository 252 is also responsible for archiving and purging audit records in accordance with system policies as defined in the audit policy catalog 230 of server 1500.

It should be noted that, in alternative embodiments, it is contemplated to utilize multiple data repositories to accommodate different record types. For example, multiple data repositories may be used to store intrusion detection records in one repository and regulatory audit records in another repository. It should also be appreciated that the use of multiple data repositories is not limited to sorting by record type and may depend on other criteria in accordance with the needs of an application.

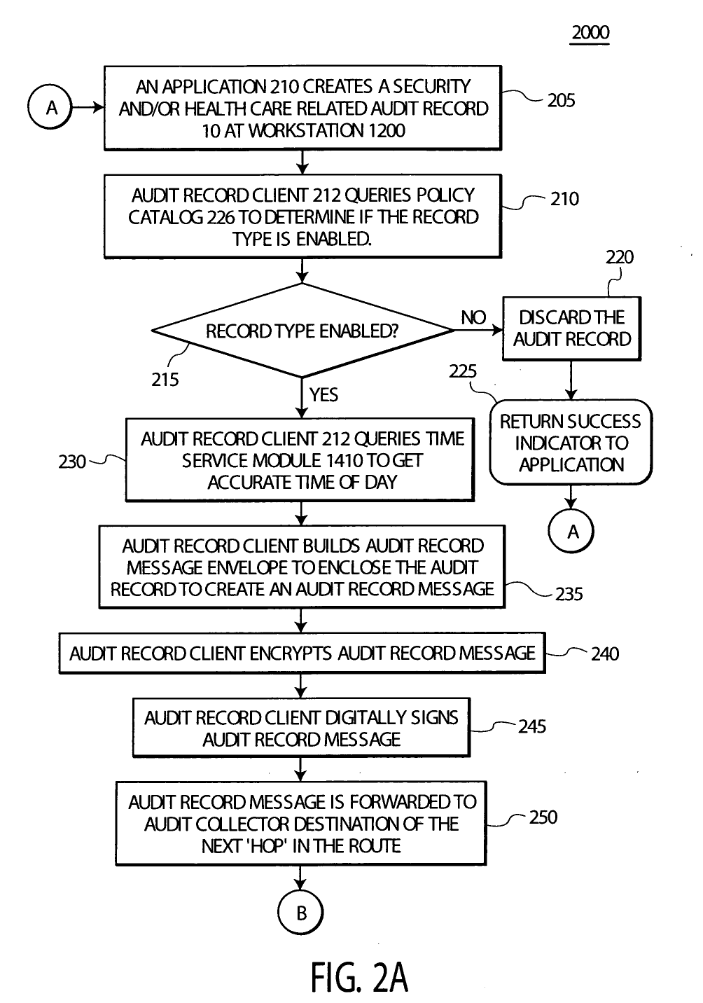

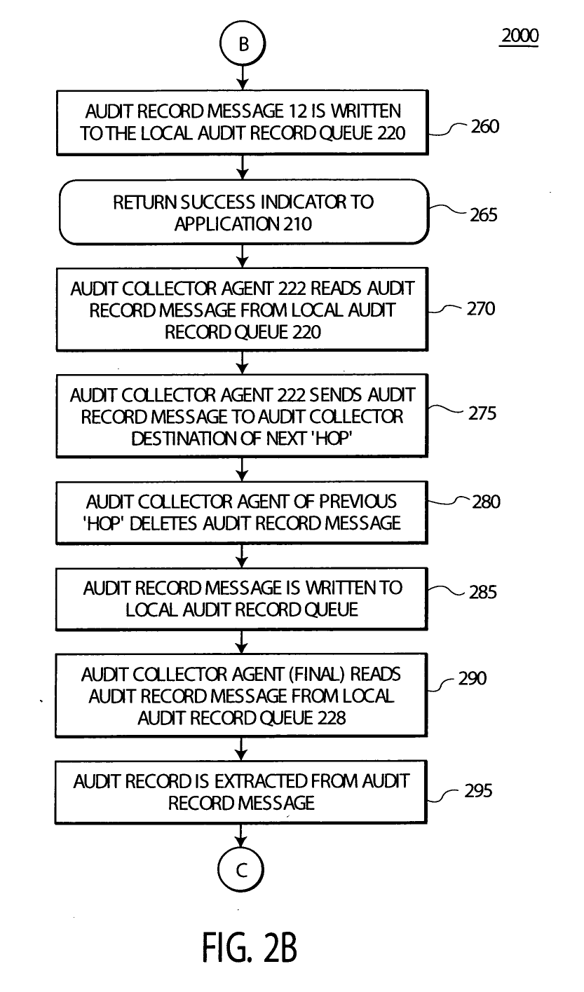

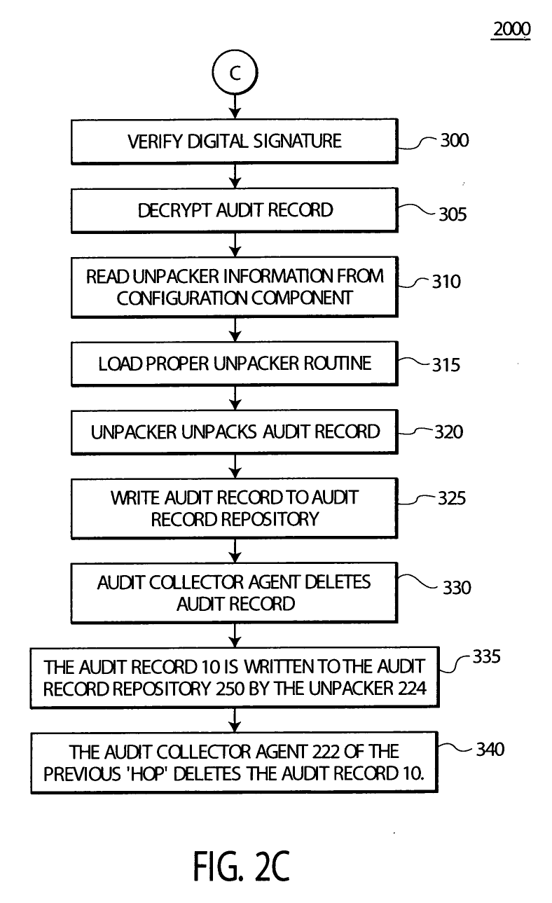

FIG. 2 is a flow chart of an exemplary embodiment of a method 2000 of the present invention for processing audit records.

At activity 205, an application 210 creates a security and/or health care related audit record 10 at workstation 1200. An audit record 10 is configured as a standard data structure containing data corresponding to a single auditable event. Specifically, the audit record 10 is comprised of an audit record “type” to classify the record, a format identifier, a timestamp and configuration information necessary to route the audit record 10 to the audit record repository 252.

At activity 210, the audit record client 212 of workstation 1200 queries the audit policy catalog 230, resident at server 1500, to determine if the audit record “type” is enabled. Policies contained within the audit policy catalog 230 exist in one of two states, enabled or disabled. In the case where a policy is enabled, the audit record types contained in the policy are collected. Conversely, in the case where a policy is disabled, the record types contained in the policy are not collected.

At activity 215, it is determined whether the audit record type is enabled or disabled.

At activity 220, the audit record 10 is discarded based on a determination at activity 215 that the audit record type is disabled.

At activity 225, the audit record client 212 returns a “success” indicator to the application 210 that generated the audit record indicating that the audit record has been discarded. The process returns to activity 205 to process the next audit record.

At activity 230, the audit record client 212 queries the time service module 1410 of the time service server 1400 to retrieve an accurate time of day.

At activity 235, an audit record message envelope is built by the audit record client 212 to enclose the audit record 10 and create an audit record message 12. An audit record message 12 is created to include additional information that is required by the system, such as, for example, the location of the audit record repository 252 to store the audit record 10. The additional information may also include, for example, the identity of the customer for whom the audit record 10 is generated. The audit record message envelope needs to include the information necessary to get the audit record 10 to the audit record repository 252, as well as whatever diagnostic information (i.e., date & time the envelope is built, for example) is deemed necessary. Such information is stored in the configuration subsystem 223 (shown as a component of server 1600). This additional information pertinent to the system is retrieved from the configuration subsystem 223 and added to the audit record 10 in a mechanism referred to as “enveloping”. This additional information is kept with the audit record 10 while it is being stored and forwarded within the system 1000. Before an audit record 10 is stored in the audit record repository 252, the “envelope” is removed from the audit record message 12, and the audit record 10 is restored to its original state.

An audit record “envelope” includes a format identifier that indicates the format of the data in the audit record 10 and the identifier of the audit record repository that the audit record is to be delivered to. An unpacker 224, shown as a component of remote server 1700, uses the format identifier and the identifier of the audit record repository 252 to query the configuration subsystem 223 to identify the appropriate unpacker to be used. This is performed at the last ‘hop’ in the route, described below.

At activity 240, the audit record message 12 is encrypted by the audit record client 212.

At activity 245, the audit record message 12 is digitally signed by the audit record client 212.

It is noted that the store and forward mechanism, described above, is performed at activities 250 through 275. These activities are repeated for as many intermediate ‘hops’ as may exist in the network.

At activity 250, the audit record message 12 is sent to an audit collector destination 218 of the next ‘hop’ in the route (e.g., server 1600), by the local audit collector agent 214 of workstation 1200.

At activity 260, the audit record message 12 is written from the local audit collector destination 218 of server 1600 to the local audit record collector queue 220 of server 1600.

At activity 265, a “success” indication is sent back from the audit collector agent 214 of workstation 1200 to the application 210 generating the event indicating that the audit record 10 is successfully processed.

At activity 270, the local audit collector agent 222 of server 1600 asynchronously reads the audit record message 12 stored in the local audit record collector queue 220 of server 1600.

At activity 275, the local audit collector agent 222 of server 1600 sends the audit record message 12 to an audit collector destination associated with a next ‘hop’ in the route (e.g., server 1700).

At activity 280, the audit collector agent 222 of the previous ‘hop’ deletes the audit record message 12.

At activity 285, the audit record message 12 is written to the local audit record queue 228 of server 1700.

At activity 290, the unpacker 224, acting in the capacity of an audit collector agent, reads the audit record message 12 from the local audit record queue 228 of server 1700. Server 1700 represents a final ‘hop’ in the route. At this point in the process, the audit record message 12 moves from the system of the invention to an external system. Server 1700 exists on the boundary of the system. As such, it does not utilize an audit collector agent and uses an unpacker 224 in its place.

At activity 295, the audit record 10 is extracted from the audit record message 12.

At activity 300, the digital signature of the extracted audit record 10 is verified.

At activity 305, the audit record 10 is decrypted.

At activity 310, unpacker information is read from the configuration subsystem 223 for the record type of the extracted audit record 10.

At activity 315, the proper unpacker routine is loaded.

At activity 320, the unpacker 224 unpacks the audit record 10.

At activity 325, the audit record 10 is written to the audit record repository 252 of server 1800 by the unpacker 224.

At activity 330, the audit collector agent 222 of the previous ‘hop’ (i.e., server 1600) deletes the audit record 10.

At activity 335, the audit record 10 is written to the audit record repository 252 by the unpacker 24.

At activity 340, the audit collector agent 222 of the previous ‘hop’ deletes the audit record 10.

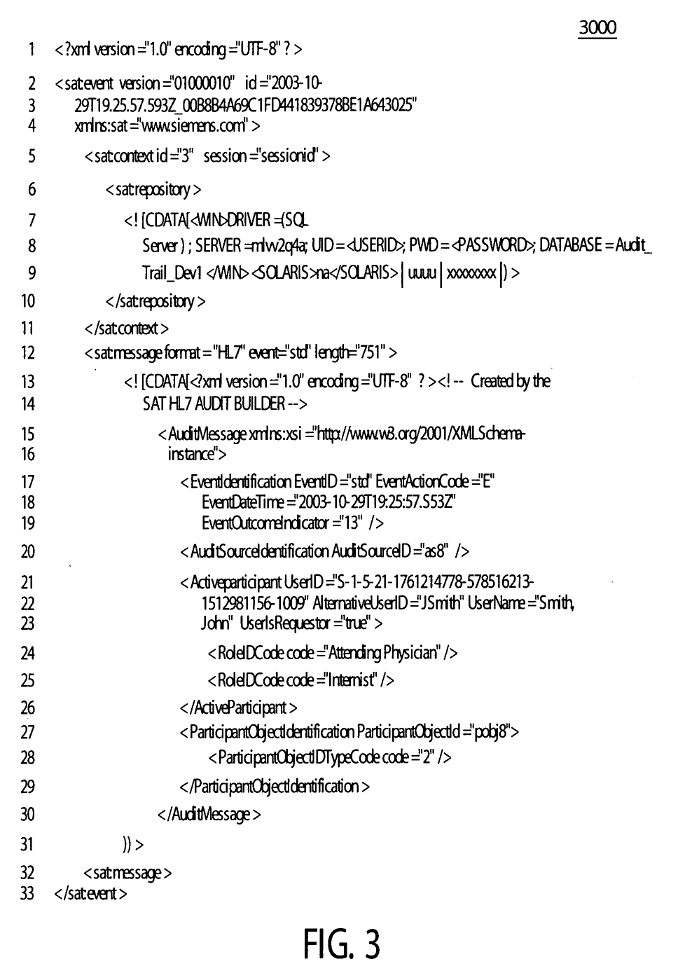

FIG. 3 is an illustration of an exemplary audit record message 3000. Line 1 contains a standard XML heading. The “sat:event” tag shown on lines 24 and 33 contain the audit record message. In other words, the syntax of XML (which is the format of the sample record) defines a start tag and an end tag. The tag refers to everything between the start and end. An end tag is similar to a start tag, except for the presence of a “/” at the beginning. The sat:event tag thus refers to and includes everything between lines 2 (start tag) through 33 (end tag) inclusive. It has a property to describe the version of the system and a unique identifier for the audit record message 12. The “sat:context” tag shown on lines 5 and 11 contain configuration information that is deployment specific. The configuration information enables the system to properly route and store the audit record 10. In particular, the “sat:repository” tag specifies the information necessary to bind to the audit record repository 252. The “sat:message” tag shown on lines 12 and 32, contain the actual audited information. This tag contains properties to describe the format of the contained audit (the “format=” property) and the ID of the event (the “Event=” property). There is also a property to describe the length of the underlying audit record.

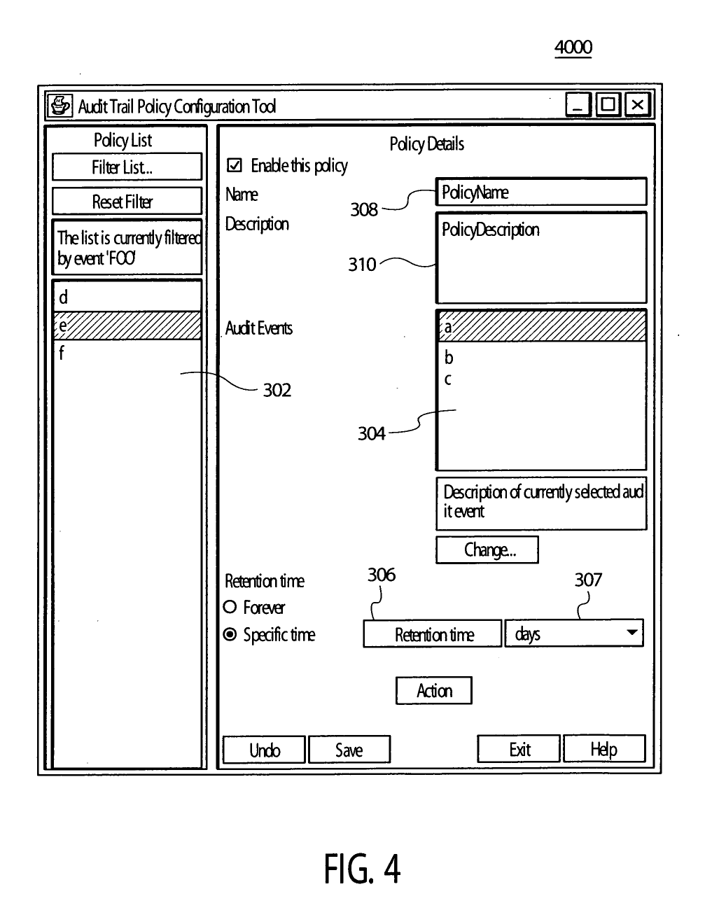

FIG. 4 illustrates one embodiment of a policy management screen 4000 which illustrates an exemplary user interface (UI) screen to allow an administrator to add, delete or modify existing audit policies. The policy management screen 4000, is provided as a MicroSoft Window™-type display in the exemplary embodiment as a main policy management screen. As shown, existing polices (e.g., polices d, e and f) are shown in a window 302 on the left hand side of the policy management screen 4000 and the currently selected policy, policy “e”, is shown as enabled and includes three events (a, b and c) in a window 304 on the right hand side of the policy management screen 4000. An administrator can specify additional information about the policies, including a retention time for the policy 306, shown in the lower portion of the policy management screen 4000. It is noted that the retention time can be specified as “Forever” (never to be purged) or as a “Specific time” in days via a drop down menu 307. Policy management screen 4000 also includes policy name 308 and policy description 310 entry boxes, both shown in the upper portion of the policy management screen 4000.

Although the invention has been described with reference to specific embodiments thereof, it will be understood that numerous variations, modifications and additional embodiments are possible, and accordingly, all such variations, modifications, and embodiments' are to be regarded as being within the spirit and scope of the invention. Accordingly, the drawings and descriptions are to be regarded as illustrative in nature, and not as restrictive.

1. A system for processing an audit record, said audit record indicating an event associated with a particular user initiating an action performed on a particular object, comprising:
an acquisition processor for acquiring message data including data representing an audit record of a particular type;
an audit data processor for,
creating a copy of said received audit record,
communicating data representing said received audit record to a destination in response to predetermined configuration information determining audit record processing requirements,
receiving message data indicating confirmation said destination has successfully received said communicated audit record, and
re-communicating a copy of said received audit record to said indicated destination, in response to failure to receive a confirmation.

2. A system according to claim 1, wherein
said audit data processor deletes said created copy of said received audit record, in response to receiving confirmation said destination has successfully received said communicated audit record.

3. A system for processing an audit record, said audit record indicating an event associated with a particular user initiating an action performed on a particular object, comprising:
an acquisition processor for acquiring message data including data representing an audit record of a particular type;
a repository of information indicating whether an audit record of a particular type is to be communicated to a destination; and
an audit data processor for,
creating a copy of said received audit record,
communicating data representing said received audit record to a destination in response to said information in said repository,
receiving a confirmation message indicating said destination has successfully received said communicated data representing said audit record, and
re-communicating data representing a copy of said received audit record to said indicated destination, in response to failure to receive a confirmation.

4. A system according to claim 3, wherein
said audit data processor deletes said created copy of said received audit record, in response to receiving confirmation said destination has successfully received said communicated audit record.

5. A system according to claim 3, wherein
said audit data processor, in said communicating and re-communicating steps, communicates and re-communicates respectively, data representing at least one of, (a) a copy and (b) an original version of said received audit record, to said destination.

6. A system according to claim 3, wherein
said particular object comprises at least one of, (a) a data item, (b) multiple data items, (c) an action and (d) an executable procedure.

7. A system according to claim 3, wherein
said message data including data representing said audit record includes at least two of, (a) a record type identifier identifying a type of said audit record, (b) a record data format identifier, (c) a time and date identifier identifying a time and date associated with said audit record and (d) information for use in identifying a destination to which said received audit record s to be communicated.

8. A system according to claim 3, wherein
said information in said repository indicates rules including at least one of, (a) whether an audit record of a particular type is to be communicated to a destination, (b) whether an audit record of a particular type is to be acquired and (c) a retention requirement of an audit record of a particular type.

9. A system according to claim 8, wherein
said information in said repository includes rules for a plurality of different audit record types.

10. A system according to claim 3, wherein
said audit data processor encrypts data representing an audit record and communicates an encrypted audit record data to a destination.

11. A system for processing an audit record, said audit record indicating an event associated with a particular user initiating an action performed on a particular object, comprising:
an acquisition processor for receiving message data including data representing an audit record;
an audit data processor for,
extracting from said received message data,
a data format identifier indicating a data format of said audit record and
an identifier indicating a destination repository for retaining said audit record and
employing said destination repository identifier in selecting a procedure to use in processing data representing said audit record to be suitable for communication to said destination repository; and
a storage processor for communicating data representing said processed data representing said audit record to said destination repository for retaining said audit record.

12. A system according to claim 11, wherein
said audit data processor employs said data format identifier in at least one of, (a) selecting a procedure to use in processing data representing said audit record to be suitable for communication to said destination repository and (b) processing data representing said audit record to be suitable for communication to said destination repository.

13. A system according to claim 11, wherein
said acquisition processor receives message data including encrypted data representing an audit record
said audit data processor decrypts said encrypted data representing said audit record to provide a decrypted audit record suitable for communication to said destination repository.

14. A system according to claim 11, wherein
said audit data processor adaptively selects a procedure, to use in processing data representing said audit record, from a plurality of procedures.

15. A system according to claim 14, wherein
said plurality of procedures are used for processing a corresponding plurality of audit records having at least one of, (a) different record type, (b) different destination repositories and (c) different data formats.

16. A system according to claim 11, wherein
said audit data processor adaptively initiates an instance of a selected procedure, to use in processing data representing said audit record.

17. A user interface system supporting user configuration of a method for processing an audit record, said audit record indicating an event associated with a particular user initiating an action performed on a particular object, comprising:
a display generator for initiating generation of at least one display image enabling a user to indicate and store configuration information including at least one of,
a destination repository and
an audit record data format, associated with a particular type of received audit record
an audit data processor for,
extracting from said received message data representing an audit record type and
comparing said data representing said audit record type with said configuration information to select a procedure to use in processing data representing said audit record to be suitable for storage in said destination repository.
